(19) United States
(12) Patent Application Publication
(10) Pub. No.: US 2026/0319693 A1
(43) Pub. Date: Oct. 15, 2026

(54) VOLTAGE-DEPENDENT CONFIGURATIONS FOR MEMORY SYSTEMS

(71) Applicant: Micron Technology, Inc., Boise, ID (US)

(72) Inventors: Marcos Alvarez Gonzalez, München (DE); Martin Bach, München (DE); Mani Balakrishnan, München (DE); Marc Walter, München (DE); Filippo Vitale, Dachau (DE); Sebastien Thomet, Aying (DE); Hemant Madhewar, München (DE)

(21) Appl. No.: 19/635,213

(22) Filed: Mar. 31, 2026

Related U.S. Application Data
(60) Provisional application No. 63/789,338, filed on Apr. 15, 2025.

(51) Int. Cl. G06F 3/06

(52) U.S. Cl. CPC G06F 3/0655; G06F 3/0604; G06F 3/0673

(57) ABSTRACT

Methods, systems, and devices for voltage-dependent configurations for memory systems are described. Techniques described herein may enable a memory system to autonomously update parameter values based on a change in a supply voltage range value. For example, the memory system may identify a value of a mode register bit that indicates the supply voltage. The memory system may determine (e.g., based on a look-up table) one or more parameter values that are based on the supply voltage value, and may adjust respective values of the one or more parameters accordingly. In some examples, the parameters may be associated with receiver properties (e.g., receiver strength, receiver operating point) or off-chip driver (OCD) equalization and may be associated with a respective frequency threshold or eye setting of the memory system

### CROSS REFERENCE

The present application for patent claims priority to U.S. Patent Application No. 63/789,338 by Alvarez Gonzalez et al., entitled “VOLTAGE-DEPENDENT CONFIGURATIONS FOR MEMORY SYSTEMS,” filed Apr. 15, 2025, which is assigned to the assignee hereof, and which is expressly incorporated by reference in its entirety herein.

### TECHNICAL FIELD

The following relates to one or more systems for memory, including voltage-dependent configurations for memory systems.

### BACKGROUND

Memory devices are used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored by the memory cell. To store information, a memory device may write (e.g., program, set, assign) states to the memory cells. To access stored information, a memory device may read (e.g., sense, detect, retrieve, determine) states from the memory cells.

### BRIEF DESCRIPTION OF THE DRAWINGS

FIG. 1 shows an example of a system that supports voltage-dependent configurations for memory systems in accordance with examples as disclosed herein.

FIG. 2 shows an example of a mode register that supports voltage-dependent configurations for memory systems in accordance with examples as disclosed herein.

FIG. 3 shows an example of a circuit diagram that supports voltage-dependent configurations for memory systems in accordance with examples as disclosed herein.

FIG. 4 shows an example of a circuit diagram that supports voltage-dependent configurations for memory systems in accordance with examples as disclosed herein.

FIG. 5 shows an example of a block diagram that supports voltage-dependent configurations for memory systems in accordance with examples as disclosed herein.

FIG. 6 shows a block diagram of a memory system that supports voltage-dependent configurations for memory systems in accordance with examples as disclosed herein.

FIG. 7 shows a flowchart illustrating a method or methods that support voltage-dependent configurations for memory systems in accordance with examples as disclosed herein.

### DETAILED DESCRIPTION

In some examples, a memory system may be associated with a data rate that is dependent on a value of a supply voltage (e.g., VDD, VDDQ). For example, memory systems with a relatively higher VDDQ may be associated with a relatively higher data rate than memory systems with a relatively lower VDDQ. In some examples, one or more parameters (e.g., off-chip driver (OCD) equalization parameters, receiver strength parameters, receiver operating point parameters) may be associated with different performance for a given value depending on the voltage level of VDDQ (e.g., and accordingly a current data rate) of the memory system. For example, a first OCD equalization parameter may be associated with a relatively higher performance for a VDDQ of 1.2 V, and a second OCD equalization parameter may be associated with a relatively higher performance for a VDDQ of 1.0 V.

Accordingly, techniques described herein may enable a memory system to autonomously update parameter values based on a change in a VDDQ value. For example, the memory system may identify a value of a mode register bit that indicates the VDDQ value. The memory system may determine one or more parameter values that are based on the VDDQ value, and may adjust respective values of the one or more parameters accordingly. In some examples, the parameters may be associated with receiver properties (e.g., receiver strength, receiver operating point) or OCD equalization and may be associated with a respective frequency threshold or eye setting of the memory system.

In addition to applicability in memory systems as described herein, techniques for adapting parameters based on configured voltage ranges may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by improving access speeds, which may decrease processing or latency times, improve response times, or otherwise improve user experience, among other benefits.

Features of the disclosure are illustrated and described in the context of systems and architectures. Features of the disclosure are further illustrated and described in the context of block diagrams, mode register diagrams, circuit diagrams, and flowcharts.

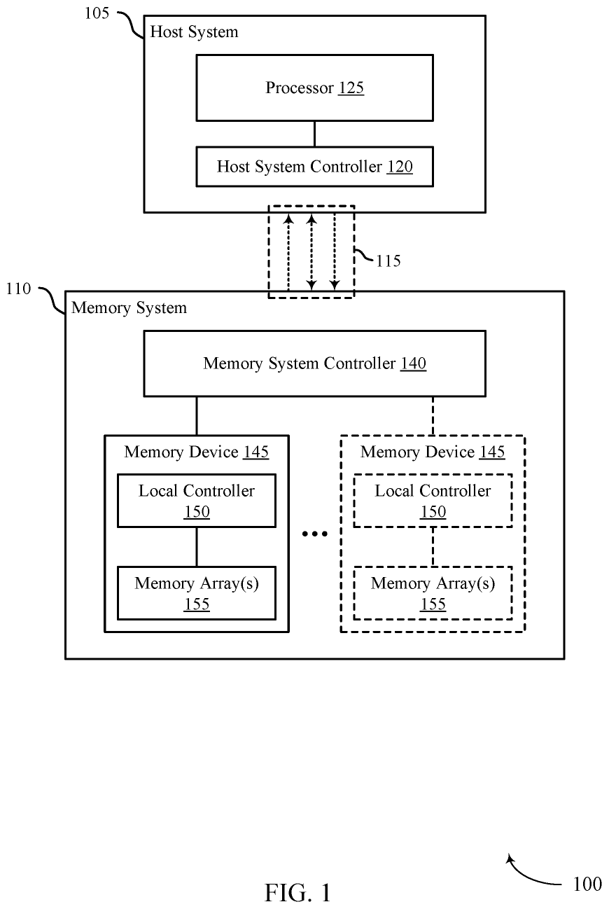

FIG. 1 shows an example of a system 100 that supports voltage-dependent configurations for memory systems in accordance with examples as disclosed herein. The system 100 may include portions of an electronic device, such as a computing device, a mobile computing device, a wireless communications device, a graphics processing device, a vehicle, a smartphone, a wearable device, an internet-connected device, a vehicle controller, a system on a chip (SoC), or other stationary or portable electronic system, among other examples. The system 100 includes a host system 105, a memory system 110, and one or more channels 115 coupling the host system 105 with the memory system 110 (e.g., to support a communicative coupling). The system 100 may include any quantity of one or more memory systems 110 coupled with the host system 105.

A host system 105 may include one or more components (e.g., circuitry, processing circuitry, application processing circuitry, one or more processing components) that use memory to execute processes (e.g., applications, functions, computations), any one or more of which may be referred to as or be included in a processor 125 (e.g., an application processor). A processor 125 may include at least one of one or more processing elements that may be co-located or distributed, including a general-purpose processor, a digital signal processor (DSP), an application-specific integrated circuit (ASIC), a field-programmable gate array (FPGA) or other programmable logic device, a controller, discrete gate or transistor logic, one or more discrete hardware components, or a combination thereof. A processor 125 may be an example of a central processing unit (CPU), a graphics processing unit (GPU), a general-purpose GPU (GPGPU), or an SoC or a component thereof, among other examples.

A host system 105 may also include at least one of one or more components (e.g., circuitry, logic, instructions) that implement the functions of an external memory controller (e.g., a host system memory controller), which may be referred to as or be included in a host system controller 120. For example, a host system controller 120 may issue commands or other signaling for operating a memory system 110, such as write commands, read commands, configuration signaling or other operational signaling. In some examples, a host system controller 120, or associated functions described herein, may be implemented by or be part of a processor 125. For example, a host system controller 120 may be hardware, instructions (e.g., software, firmware), or a combination thereof implemented by a processor 125 or other component of a host system 105. In various examples, a host system 105 or a host system controller 120 may be referred to as a host.

A memory system 110 provides physical memory locations (e.g., addresses) that may be used or referenced by the system 100. A memory system 110 may include a memory system controller 140 and one or more memory devices 145 (e.g., memory packages, memory dies, portions of a memory die) operable to store data. A memory system 110 may be configurable for operations with different types of host systems 105, and may respond to commands from the host system 105 (e.g., from a host system controller 120). For example, a memory system 110 (e.g., a memory system controller 140) may receive a write command indicating that the memory system 110 is to store data received from a host system 105, or receive a read command indicating that the memory system 110 is to provide data stored in a memory device 145 to a host system 105, or receive a refresh command indicating that the memory system 110 is to refresh data stored in a memory device 145, among other types of commands and operations.

A memory system controller 140 may include at least one of one or more components (e.g., circuitry, logic, instructions) operable to control operations of a memory system 110. A memory system controller 140 may include hardware or instructions that support the memory system 110 performing various operations, and may be operable to receive, transmit, or respond to commands, data, or control information related to operations of the memory system 110. A memory system controller 140 may be operable to communicate with one or more of a host system controller 120, one or more memory devices 145, or a processor 125. In some examples, a memory system controller 140 may control operations of the memory system 110 in cooperation with a host system controller 120, a local controller 150 of a memory device 145, or any combination thereof. Although the example of memory system controller 140 is illustrated as a separate component of the memory system 110, in some examples, aspects of the functionality of the memory system 110 may be implemented by a processor 125, a host system controller 120, at least one of one or more local controllers 150, or any combination thereof.

Each memory device 145 may include a local controller 150 (e.g., a logic controller, an interface controller, one or more processors) and one or more memory arrays 155. A memory array 155 may be a collection of memory cells (e.g., a two-dimensional array, a three-dimensional array, an array of one or more semiconductor components), with each memory cell being operable to store data (e.g., as one or more stored bits). Each memory array 155 may include memory cells of various architectures, such as random access memory (RAM) cells, dynamic RAM (DRAM) cells, synchronous dynamic RAM (SDRAM) cells, static RAM (SRAM) cells, ferroelectric RAM (FeRAM) cells, magnetic RAM (MRAM) cells, resistive RAM (RRAM) cells, phase change memory (PCM) cells, chalcogenide memory cells, not- or (NOR) memory cells, and not- and (NAND) memory cells, or any combination thereof.

A local controller 150 may include at least one of one or more components (e.g., circuitry, logic, instructions) operable to control operations of a memory device 145. In some examples, a local controller 150 may be operable to communicate (e.g., receive or transmit data or commands or both) with a memory system controller 140. In some examples, a memory system 110 may not include a memory system controller 140, and a local controller 150 or a host system controller 120 may perform functions of a memory system controller 140 described herein. In some examples, a local controller 150, or a memory system controller 140, or both may include decoding components operable for accessing addresses of a memory array 155, sense components for sensing states of memory cells of a memory array 155, write components for writing states to memory cells of a memory array 155, or various other components operable for supporting described operations of a memory system 110.

A host system 105 (e.g., a host system controller 120) and a memory system 110 (e.g., a memory system controller 140) may communicate information (e.g., data, commands, control information, configuration information, timing information) using one or more channels 115. Each channel 115 may be an example of a transmission medium that carries information, and each channel 115 may include one or more signal paths (e.g., a transmission medium, an electrical conductor, a conductive path) between terminals (e.g., nodes, pins, contacts) associated with the components of the system 100. A terminal may be an example of a conductive input or output point of a device of the system 100, and a terminal may be operable as part of a channel 115. In some implementations, at least the channels 115 between a host system 105 and a memory system 110 may include or be referred to as a host interface (e.g., a physical host interface). To support communications over channels 115, a host system 105 (e.g., a host system controller 120) and a memory system 110 (e.g., a memory system controller 140) may include receivers (e.g., latches) for receiving signals, transmitters (e.g., drivers) for transmitting signals, decoders for decoding or demodulating received signals, or encoders for encoding or modulating signals to be transmitted, among other components that support signaling over channels 115, which may be included in a respective interface portion of the respective system.

A channel 115 may be dedicated to communicating one or more types of information, and channels 115 may include unidirectional channels, bidirectional channels, or both. For example, the channels 115 may include one or more command/address channels, one or more clock signal channels, one or more data channels, among other channels or combinations thereof. In some examples, a channel 115 may be configured to provide power from one system to another (e.g., from the host system 105 to the memory system 110, in accordance with a regulated voltage). In some examples, at least a subset of channels 115 may be configured in accordance with a protocol (e.g., a logical protocol, a communications protocol, an operational protocol, an industry standard), which may support configured operations of and interactions between a host system 105 and a memory system 110.

A command/address channel (e.g., a CA channel) may be operable to communicate commands between the host system 105 and the memory system 110, including control information associated with the commands (e.g., address information, configuration information). Commands carried by a command/address channel may include a write command with an address for data to be written to the memory system 110 or a read command with an address of data to be read from the memory system 110.

A clock signal channel may be operable to communicate one or more clock signals between the host system 105 and the memory system 110. Clock signals may oscillate between a high state and a low state, and may support coordination (e.g., in time) between operations of the host system 105 and the memory system 110. In some examples, a clock signal may provide a timing reference for operations of the memory system 110. A clock signal may be referred to as a control clock signal, a command clock signal, or a system clock signal. A system clock signal may be generated by a system clock, which may include one or more hardware components (e.g., oscillators, crystals, logic gates, transistors).

A data channel (e.g., a DQ channel) may be operable to communicate (e.g., bidirectionally) information (e.g., data, control information) between the host system 105 and the memory system 110. For example, a data channel may communicate information from the host system 105 to be written to the memory system 110, or information read from the memory system 110 to the host system 105. In some examples, channels 115 may include one or more error detection code (EDC) channels. An EDC channel may be operable to communicate error detection signals, such as checksums or parity bits, which may accompany information conveyed over a data channel.

Signals communicated over the channels 115 may be modulated using various modulation schemes or combinations thereof. A symbol of a binary-symbol (e.g., binary-level) modulation scheme may be operable to represent one bit of data (e.g., a symbol may represent a logic 1 or a logic 0), and may be an example of an M-ary modulation scheme where Mis equal to two. Examples of binary-symbol modulation schemes include non-return-to-zero (NRZ), unipolar encoding, bipolar encoding, Manchester encoding, pulse amplitude modulation (PAM) having two symbols (e.g., PAM2), having three symbols (e.g., PAM3) and others. A symbol of a multi-symbol modulation scheme may be operable to represent more than one bit of data (e.g., a symbol may represent a logic 00, a logic 01, a logic 10, or a logic 11), and may be an example of an M-ary modulation scheme where Mis greater than or equal to three. For example, a multi-symbol signal may be modulated using a modulation scheme that includes at least three levels to encode more than one bit of information. Multi-symbol modulation schemes and symbols may be referred to as non-binary, multi-bit, or higher-order modulation schemes and symbols. Examples of multi-symbol modulation schemes include PAM3, PAM4, PAM8, and so on, quadrature amplitude modulation (QAM), quadrature phase shift keying (QPSK), and others.

In some examples of the system 100, a memory system 110 may autonomously update parameter values based on a change in a VDDQ value. For example, the memory system 110 may identify a value of a mode register bit that indicates the VDDQ value. The memory system 110 may determine (e.g., based on a look-up table) one or more parameter values that are based on the VDDQ value, and may adjust respective values of the one or more parameters accordingly. In some examples, the parameters may be associated with receiver properties (e.g., receiver strength, receiver operating point) or OCD equalization and may be associated with a respective frequency threshold or eye setting of the memory system 110. The memory system 110 may accordingly operate using the indicated parameter values, which may increase a performance (e.g., access speeds, data rate) of the memory system 110.

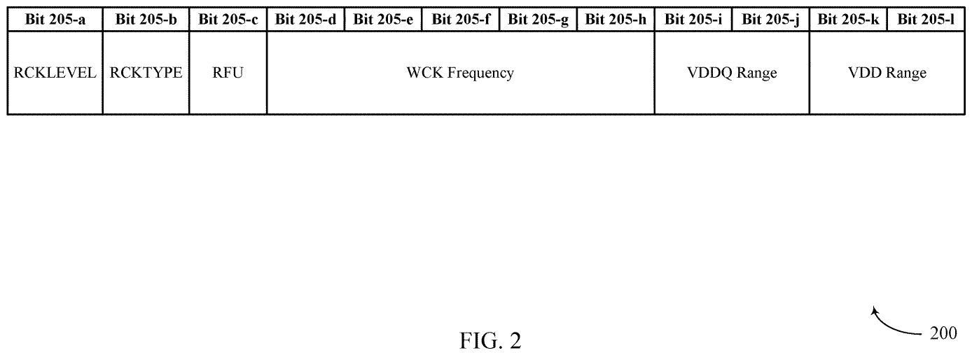

FIG. 2 shows an example of a mode register 200 that supports voltage-dependent configurations for memory systems in accordance with examples as disclosed herein. The mode register 200 may implement or may be implemented by aspects of the system 100. For example, the mode register 200 may be implemented by a memory system 110, which may be an example of the corresponding device as described with reference to FIG. 1.

In some examples, a memory system 110 may operate using one or more supply voltages. For example, the memory system 110 may use a first supply voltage as a supply for one or more input buffers (e.g., a voltage VDD) and a second supply voltage as a supply for one or more output buffers (e.g., a voltage VDDQ). In some examples, the memory system 110 may enable dynamic selection of one or more voltage ranges for each supply voltage. For example, a user may select for the memory system to operate with a VDD and VDDQ of 1.20 volts (V), 1.10 V, and/or 1.00 V. Each supply voltage range may be associated with a respective data rate of the memory system 110. For example, a relatively higher voltage range for the supply voltages may correspond to a relatively higher data rate of the memory system 110.

In some examples, one or more features of the memory system 110 be associated with a different performance depending on the data rate of the memory system 110. For example, a first voltage range may be associated with a relatively smaller eye setting (e.g., and accordingly relatively more errors) at a first receiver operating point than at a second receiver operating point, and a second voltage range may be associated with a relatively larger eye setting (e.g., and accordingly relatively fewer errors) at the first receiver operating point than at the second receiver operating point. Additionally, in some examples, the memory system 110 may use a relatively larger receiver strength to achieve a relatively higher data rate. However, the relatively larger receiver strength may increase power consumption of the memory system 110, and may not increase the data rate for relatively lower supply voltage ranges. The memory system 110 may therefore user a higher receiver strength for higher supply voltage ranges and a lower receiver strength for lower supply voltage ranges.

A performance of the memory system 110 may therefore be relatively better (e.g., with relatively fewer errors or relatively lower power consumption) at a first set of parameter values (e.g., parameters associated with receiver properties for CA and DQ pins, parameters associated with OCD equalization) for the first voltage range and for a second set of parameter values for a second voltage range. In some examples, however, manual adjustment of such parameter values by a user of the memory system 110 any time the supply voltage is adjusted may decrease user experience.

Accordingly, techniques described herein may enable the memory system 110 to automatically adjust the parameter values to one or more parameter values that are associated with a relatively highest performance of a configured supply voltage range. For example, the memory system 110 may retrieve a value from a mode register 200 that indicates a first voltage range (e.g., a voltage range associated with the source voltage VDDQ) and/or a second voltage range (e.g., a voltage range associated with the source voltage VDD). As an illustrative example, the mode register may include a bit 205-a indicating one or more values of a read clock level (RCKLEVEL) associated with the memory system 110, a bit 205-b indicating one or more values of a read clock type (RCKTYPE) associated with the memory system 110, a bit 205-c that may be reserved for future use (RFU), one or more bits (e.g., a bit 205-d through a bit 205-h) indicating one or more values of a write clock (WCK) frequency associated with the memory system 110, one or more bits (e.g., a bit 205-i and a bit 205-j) indicating a voltage range associated with the supply voltage VDDQ, and one or more bits (e.g., a bit 205-k and a bit 205-l) indicating a voltage range associated with the supply voltage VDD.

The value of the mode register bits corresponding to the VDDQ and VDD voltage ranges (e.g., the bit 205-i, the bit 205-j, the bit 205-k, and the bit 205-l) may update in accordance with a respective voltage range set by the user. Accordingly, the memory system 110 may retrieve the values of the bits corresponding to VDDQ and VDD to determine a voltage range of a set of voltage ranges that is configured for the memory system 110.

The memory system 110 may accordingly reference a read-only memory (e.g., a non-volatile memory, an array of fuses) to determine values of one or more operational parameters associated with the memory system 110 for the voltage ranges indicated via the mode register 200. For example, the read-only memory of the memory system 110 may indicate a first set of parameter values corresponding to a first voltage range, a second set of parameter values corresponding to a second voltage range, and the like. Each set of parameter values may be associated with a relatively higher performance of the memory system 110 than one or more other parameter values for the corresponding voltage range. In some examples, the read-only memory may indicate a look-up table of parameter values. In some examples, a first set of fuses of the read-only memory may store parameter values for a first frequency range, a second set of fuses of the read-only memory may store parameter values for a second frequency range, and so on.

The memory system 110 may accordingly adjust one or more parameters in accordance with the one or more parameter values, and may operate according to the adjusted parameters. Accordingly, a performance of the memory system 110 may be relatively higher (e.g., lower power consumption, fewer errors) than a performance of memory systems in which parameters are not dynamically updated according to supply voltage changes. Additionally, such parameters may be updated without user intervention, which may increase user experience associated with the memory system 110.

For example, the memory system 110 may retrieve, from the read-only memory, a value of a receiver strength (e.g., or a set of receiver strengths) corresponding to the supply voltage range value retrieved from the mode register. In some examples, a relatively higher supply voltage range value may correspond to a relatively higher current and data rate, and the receiver strength parameter value (e.g., a gain) may be relatively higher. A relatively lower supply voltage range value may correspond to a relatively lower current and data rate, and the receiver strength parameter value may be relatively lower. That is, the memory system 110 may disable (e.g., turn off) one or more current drivers or other receiver components to reduce power consumption if the supply voltage range value is below a threshold.

In some examples, each supply voltage range may correspond to a set of operating frequency range thresholds (e.g., data rate thresholds), where each frequency range threshold may correspond to a given receiver strength. In such examples, a relatively higher supply voltage range may correspond to relatively higher frequency range thresholds. As an illustrative example, for a VDDQ of 1.2 V, a first receiver strength may correspond to a data rate above 32 gigabits per second (Gbps), a second receiver strength may correspond to a data rate below 32 Gbps and above 22 Gbps, a third receiver strength may correspond to a data rate below 22 Gbps and above 14 Gbps, and so on. For a VDDQ of 1.2 V, a first receiver strength may correspond to a data rate above 15 gigabits per second (Gbps), a second receiver strength may correspond to a data rate below 15 Gbps and above 10 Gbps, a third receiver strength may correspond to a data rate below 10 Gbps and above 6 Gbps, and so on.

Table 1 provides op-code bit definitions for some of the fields in mode register 200. Specifically, it includes definitions for WCK Frequency, VDDQ Range, and VDD Range.

TABLE 1

| | Bit | |
|---|---|---|
| Function | Index (OP) | Data |
| V_{DD} Range | OP[1:0] | V_{DD} Range |
| | | 00b: 1.20 V (default) |
| | | 01b: 1.10 V |
| | | 10b: Reserved |
| | | 11b: Reserved |
| V_{DDQ} Range | OP[3:2] | V_{DDQ} Range |
| | | 00b: 1.20 V (default) |
| | | 01b: 1.10 V |
| | | 10b: Reserved |
| | | 11b: 1.00 V |
| WCK | OP[8:4] | WCK Frequency range |
| Frequency | | 00000b: WCK ≤ WCKNRZ (default) |
| | | 00001b: WCK < 0.5 GHz |
| | | 00010b: 0.5 GHz ≤ WCK < 1.0 GHz |
| | | 00011b: 1.0 GHz ≤ WCK < 1.5 GHz |
| | | . . . |
| | | 01110b: 6.5 GHz ≤ WCK < 7.0 GHz |
| | | 01111b: 7.0 GHz ≤ WCK < 7.5 GHz |
| | | 10000b: 7.5 GHz ≤ WCK < 8.0 GHz |
| | | 10001b: 8.0 GHz ≤ WCK < 8.5 GHz |
| | | 10010b: 8.5 GHz ≤ WCK < 9.0 GHz |
| | | All others: Reserved |

Additionally, or alternatively, the memory system 110 may retrieve, from the read-only memory, a value of a receiver operating point (e.g., or a set of receiver operating points) corresponding to the supply voltage range value retrieved from the mode register. In some examples, a set of receiver strength parameters may be associated with a corresponding set of data eye sizes for an upper eye and a lower eye. As an illustrative example, at a first supply voltage range, a receiver operating point of 32 (e.g., 831 millivolts (mV)) may correspond to an upper eye size of 150 mV and a lower eye size of 115 mV, and a receive operating point of 16 (e.g., 712 mV) may correspond to an upper eye size of 132 mV and a lower eye size of 72 mV. The receiver operating point of 32 may therefore correspond to relatively larger eye sizes in the first supply voltage range, which may result in relatively fewer errors. At a second supply voltage range, the receiver operating point of 32 may correspond to relatively smaller eye sizes than the receiver operating point of 16. The receiver operating point of 32 may therefore correspond to relatively smaller eye sizes in the second supply voltage range, which may result in relatively more errors. Accordingly, the read-only memory may indicate for the memory system 110 to use the receiver operating point of 32 at the first supply voltage range and the receiver operating point of 16 at the second supply voltage range.

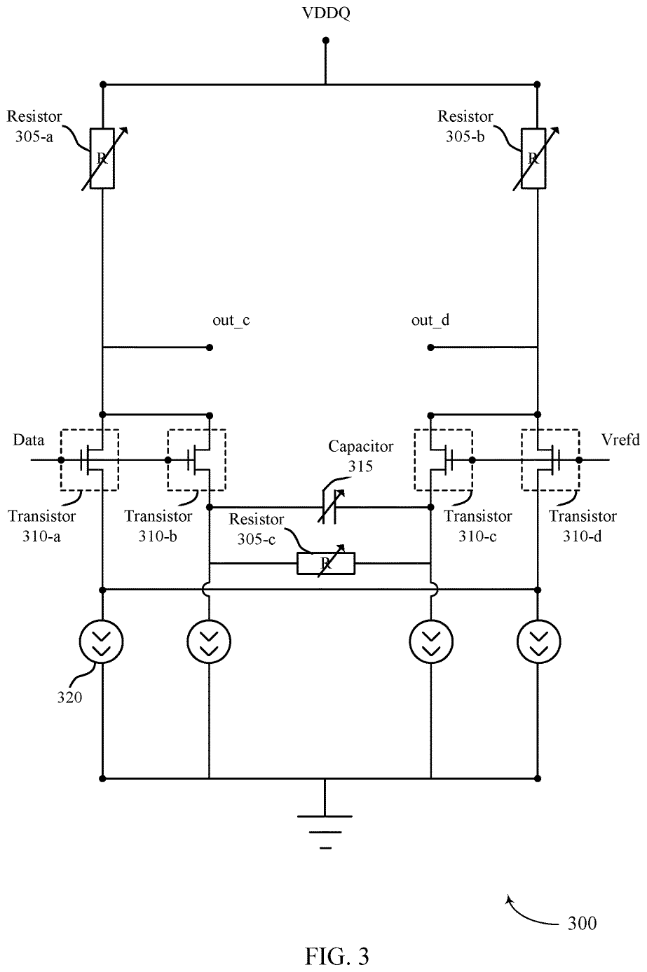

In some examples, each receiver operating point may be associated with a respective current (e.g., a preamp current) at each supply voltage range. The value of the receiver operating point may accordingly be associated with the respective current. For example, a receiver operating point at a relatively lower supply voltage range may be associated with a relatively smaller current, which may reduce power consumption as compared to a receiver operating point associated with a relatively higher current. In some examples, the receiver strength, receiver operating point, and/or one or more additional receiver parameters may be implemented via a preamp circuit, as described in further detail with reference to FIG. 3.

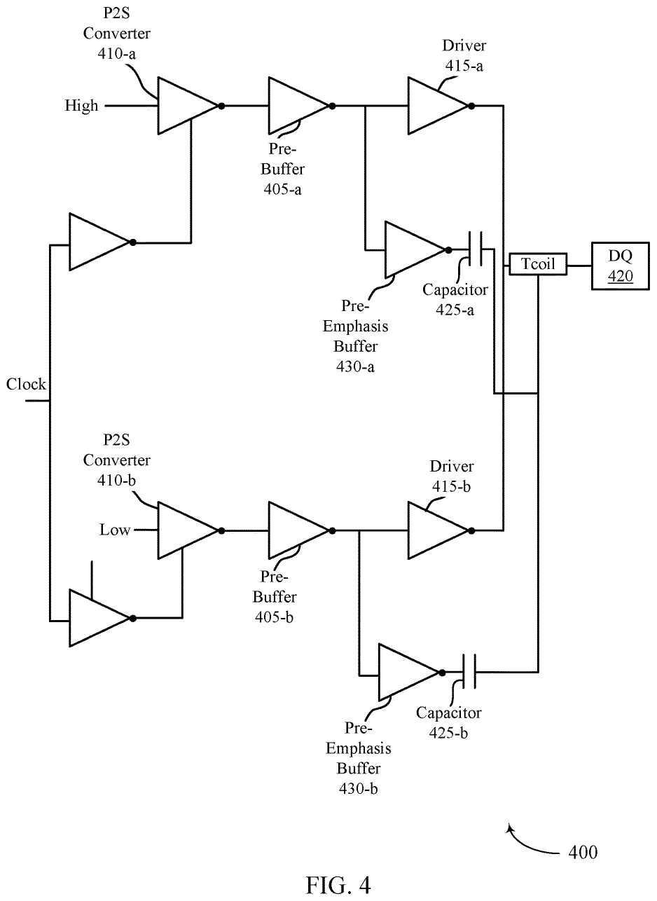

Additionally, or alternatively, the memory system 110 may retrieve, from the read-only memory, a value of one or more OCD equalization parameters (e.g., deemphasis or pre-emphasis parameters) corresponding to the supply voltage range value retrieved from the mode register. In some examples, a relatively higher supply voltage range value may correspond to a relatively higher current and data rate, and the ODC equalization parameter values may be relatively higher. A relatively lower supply voltage range value may correspond to a relatively lower current and data rate, and the ODC equalization parameter may be relatively lower. That is, the memory system 110 may disable (e.g., turn off) one or more pre-buffer components or one or more other driver components to reduce power consumption if the supply voltage range value is below a threshold. Such techniques are described in further detail with reference to FIG. 4. In some examples, each supply voltage range may correspond to a set of operating frequency range thresholds (e.g., data rate thresholds), where each frequency range threshold may correspond to a given deemphasis and pre-emphasis parameter.

FIG. 3 shows an example of a circuit diagram 300 that supports voltage-dependent configurations for memory systems in accordance with examples as disclosed herein. The circuit diagram 300 may implement or may be implemented by aspects of the system 100 or the mode register 200. For example, the circuit diagram 300 may be implemented by a memory system 110, which may be an example of the corresponding device as described with reference to FIG. 1.

The circuit diagram 300 may be an example of a preamp circuit. A receiver of a memory system 110 may obtain data via the preamp circuit. The preamp circuit may include one or more resistors (e.g., a resistor 305-a, a resistor 305-b, a resistor 305-c), one or more transistors (e.g., a transistor 310-a, a transistor 310-b, a transistor 310-c, and a transistor 310-d), and a capacitor 315. The preamp circuit may receive power from a supply voltage source VDDQ and a reference voltage Vrefd.

As described with reference to FIG. 2, the memory system 110 may determine parameter values associated with the preamp circuit based on a voltage range of the supply voltage source VDDQ (e.g., based on retrieving a value of the supply voltage range from a mode register). The memory system 110 may adjust the parameters associated with the preamp circuit based on retrieving parameter values from a read-only memory of the memory system 110 (e.g., values that correspond to the retrieved voltage range value). For example, the memory system 110 may set a receiver strength parameter of the preamp circuit to a retrieved value by adjusting a mode of the resistor 305-b. The memory system 110 may set a receiver operating point parameter of the preamp circuit to a retrieved value by applying a bias to a current 320 of the preamp circuit, which may adjust a bias value (e.g., Nbias) that is output from the preamp circuit.

FIG. 4 shows an example of a circuit diagram 400 that supports voltage-dependent configurations for memory systems in accordance with examples as disclosed herein. The circuit diagram 400 may implement or may be implemented by aspects of the system 100, the mode register 200, or the circuit diagram 300. For example, the circuit diagram 400 may be implemented by a memory system 110, which may be an example of the corresponding device as described with reference to FIG. 1.

The circuit diagram 400 may be an example of a driver circuit that may be associated with outputting data from a memory system 110. In some examples, the driver circuit may receive a clock signal. The driver circuit may process data (e.g., high and low signals, respectively) via a parallel-to-serial (P2S) converter 410-a or a P2S converter 410-b. The driver circuit may pre-buffer the data via a pre-buffer 405-a or a pre-buffer 405-b, and may drive the data via a driver 415-a and a driver 415-b (e.g., buffers with 40 Ohm termination). In some examples, the drivers 415 may boost the data (e.g., by an amount input by a user of the memory system 110, such as via a mode register set (MRS) command). The memory system 110 may process the data using a pre-emphasis buffer 430-a and a pre-emphasis buffer 430-b that may output signaling to a capacitor 425-a and a capacitor 425-b, respectively. The data may be output by the DQ 420.

In some examples, as described herein with reference to FIG. 2, the memory system 110 may adjust one or more parameters associated with OCD equalization for the driver circuit based on a voltage range value of the memory system 110. For example, the memory system 110 may obtain a voltage range value from a mode register, and may retrieve values of the one or more OCD equalization parameters from a read-only memory of the memory system that correspond to the retrieved voltage range value.

For example, the memory system 110 may determine a value of a deemphasis parameter associated with the pre-buffer 405-a or the pre-buffer 405-b corresponding to the voltage range value. The deemphasis of the pre-buffer 405-a and the pre-buffer 405-b may correspond to an amount of DC power consumption. In some examples, the deemphasis parameter may correspond to a threshold frequency at which to deactivate the pre-buffer 405-a and the pre-buffer 405-b. The memory system 110 may set the deemphasis parameter associated with the pre-buffer 405-a or the pre-buffer 405-b to the determined value. Such a value may decrease power consumption of the memory system 110. For example, the memory system 110 may deactivate the pre-buffer 405-a and the pre-buffer 405-b at a relatively lower frequency for a first supply voltage range than for a second supply voltage range, which may decrease power consumption of the memory system 110.

In some examples, the memory system 110 may determine a value of one or more other parameters associated with the pre-buffer 405-a and the pre-buffer 405-b (e.g., a switching point parameter associated with the pre-buffer 405-a and the pre-buffer 405-b). Additionally, or alternatively, the memory system 110 may determine a value of one or more pre-emphasis parameters associated with the pre-emphasis buffer 430-a or the pre-emphasis buffer 430-b. Additionally, or alternatively, the memory system 110 may determine a value of one or more parameters associated with the driver 415-a or the driver 415-b.

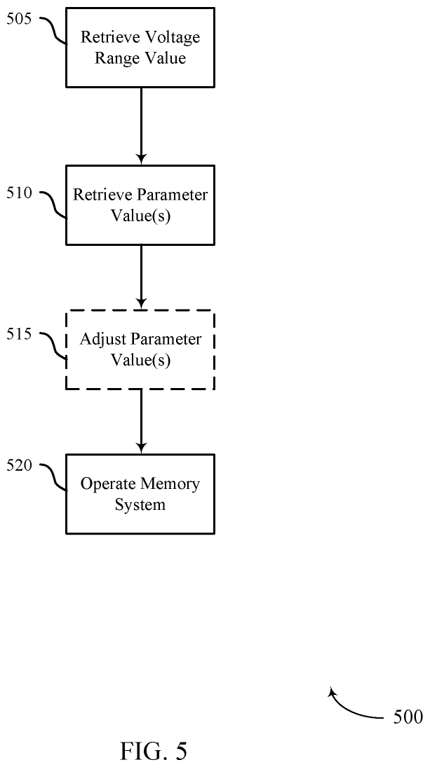

FIG. 5 shows an example of a block diagram 500 that supports voltage-dependent configurations for memory systems in accordance with examples as disclosed herein. The block diagram 500 may implement or may be implemented by aspects of the system 100, the mode register 200, the circuit diagram 300, or the circuit diagram 400. For example, the block diagram 500 may be implemented by a memory system 110, which may be an example of the corresponding device as described with reference to FIG. 1.

In the following description of the block diagram 500, the operations may occur in a different order than the example order shown and, in some examples, may be performed by one or more different devices other than those shown as examples. Some operations also may be omitted from the block diagram 500, and other operations may be added to the block diagram 500. Further, although some operations may be shown to occur at different times for discussion purposes, these operations may actually occur at the same time.

At 505, a memory system 110 may retrieve a value from a mode register. The mode register may indicate a plurality of voltage ranges of a supply voltage of the memory system. For example, the value may indicate a first voltage range value of the plurality of voltage ranges. Each voltage range may be associated with a respective data rate. In some examples, the mode register may store a second plurality of voltage ranges of a second supply voltage of the memory system 110. For example, the supply voltage may be a supply for one or more input buffers of the memory system 110 (e.g., VDD), and the second supply voltage may be a supply for one or more output buffers of the memory system (e.g., VDDQ), or vice-versa. In some examples, the mode register may include a third indication of a plurality of operating frequencies for a write clock associated with the memory system 110.

At 510, the memory system 110 may retrieve one or more values of one or more parameters. The one or more values associated with the first voltage range value. For example, the memory system 110 may retrieve the one or more parameter values from a read-only memory (e.g., an array of fuses of the memory system 110). In some examples, the read-only memory may store a look-up table of parameter values each associated with a respective one of the plurality of voltage range values.

In some examples, the one or more parameters may include one or more OCD equalization parameters, one or more receiver properties, or both. In some examples, the one or more receiver properties may be receiver strength parameters or receiver operating point parameters. The receiver strength parameters may be associated with a respective frequency threshold, where each frequency threshold is associated with a respective voltage range value. The receiver operating point parameters may be one or more receiver operating points associated with a respective eye setting of the memory system, where each eye setting is associated with a respective voltage range value. The one or more OCD parameters may be a pre-emphasis parameter, a de-emphasis parameter, or both for one or more frequency ranges. The one or more OCD parameters, the one or more frequency ranges, or both may be associated with a respective power consumption associated with each voltage range value.

In some examples, at 515, the memory system 110 may adjust respective values of the one or more parameters. For example, if the one or more parameters are set to values that are different from the one or more values associated with the voltage range value, the memory system 110 may adjust the one or more parameters to the values based on the retrieving. At 520, the memory system may operate using the retrieved parameter values. For example, the memory system 110 may receive or output data according to the retrieved parameter values.

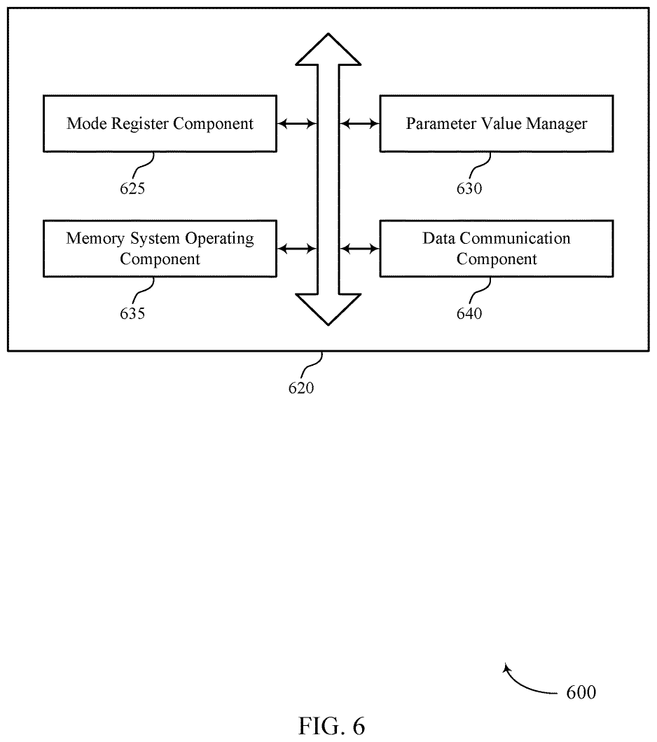

FIG. 6 shows a block diagram 600 of a memory system 620 that supports voltage-dependent configurations for memory systems in accordance with examples as disclosed herein. The memory system 620 may be an example of aspects of a memory system as described with reference to FIGS. 1 through 5. The memory system 620, or various components thereof, may be an example of means for performing various aspects of voltage-dependent configurations for memory systems as described herein. For example, the memory system 620 may include a mode register component 625, a parameter value manager 630, a memory system operating component 635, a data communication component 640, or any combination thereof. Each of these components, or components of subcomponents thereof (e.g., one or more processors, one or more memories), may communicate, directly or indirectly, with one another (e.g., via one or more buses).

The mode register component 625 may be configured as or otherwise support a means for retrieving a value from a mode register, the mode register indicating a plurality of voltage ranges of a supply voltage associated with the memory system, where the value indicates a first voltage range of the plurality of voltage ranges. The parameter value manager 630 may be configured as or otherwise support a means for retrieving, from a read-only memory associated with the memory system, values of one or more parameters associated with operation of the memory system based at least in part on the value of the mode register, where each respective value of the one or more parameters is associated with the first voltage range. The memory system operating component 635 may be configured as or otherwise support a means for operating the memory system according to the values of the one or more parameters based at least in part on retrieving the values from the read-only memory.

In some examples, the parameter value manager 630 may be configured as or otherwise support a means for adjusting a respective value of the one or more parameters to the values based at least in part on retrieving the values from the read-only memory.

In some examples, the one or more parameters include one or more off-chip driver equalization parameters, one or more receiver properties, or any combination thereof.

In some examples, the one or more receiver properties include one or more receiver strength parameters, one or more receiver operating point parameters, or any combination thereof.

In some examples, the one or more receiver strength parameters include one or more frequency thresholds, each respective frequency threshold associated with a respective receiver strength.

In some examples, the one or more receiver operating point parameters include one or more receiver operating points, each respective receiver operating points associated with a respective eye setting of the memory system.

In some examples, the one or more off-chip driver equalization parameters include a respective pre-emphasis parameter, a respective de-emphasis parameter, or both for one or more frequency ranges. In some examples, each respective pre-emphasis parameter and de-emphasis parameter is associated with a respective power consumption.

In some examples, the read-only memory includes one or more fuses storing the values of the one or more parameters.

In some examples, the read-only memory stores a look-up table indicating respective values of the one or more parameters, each respective value corresponding to a voltage range of the plurality of voltage ranges.

In some examples, each voltage range of the plurality of voltage ranges corresponds to a respective data rate for communicating data with the memory system over a data channel.

In some examples, the data communication component 640 may be configured as or otherwise support a means for communicating data over a data channel using a modulation scheme that includes three or more symbols, where the plurality of voltage ranges are associated with communicating the modulation scheme.

In some examples, the mode register includes a second indication of a second plurality of voltage ranges of a second supply voltage associated with the memory system.

In some examples, the supply voltage includes a supply voltage for one or more input buffers of the memory system. In some examples, the second supply voltage includes a supply voltage for one or more output buffers of the memory system.

In some examples, the mode register includes a third indication of a plurality of operating frequencies for a write clock associated with the memory system.

In some examples, the described functionality of the memory system 620, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 620, or various components thereof, may be implemented at least in part by instructions (e.g., stored in memory, non-transitory computer-readable medium) executable by such at least one processor.

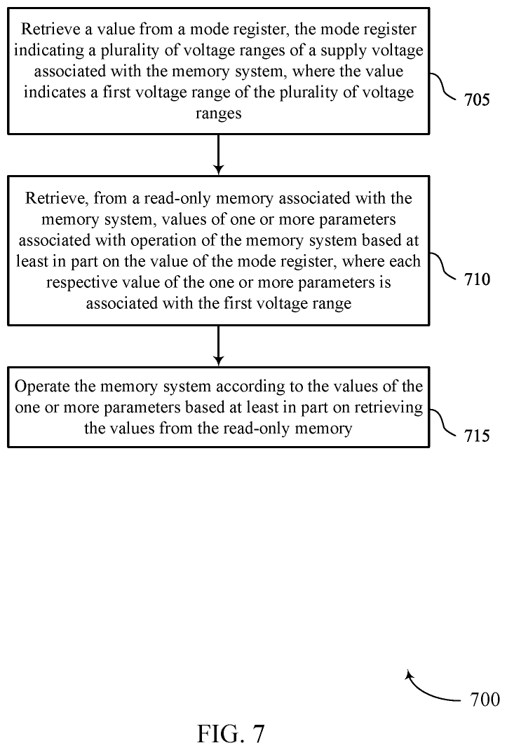

FIG. 7 shows a flowchart illustrating a method 700 that supports voltage-dependent configurations for memory systems in accordance with examples as disclosed herein. The operations of method 700 may be implemented by a memory system or its components as described herein. For example, the operations of method 700 may be performed by a memory system as described with reference to FIGS. 1 through 6. In some examples, a memory system may execute a set of instructions to control the functional elements of the device to perform the described functions. Additionally, or alternatively, the memory system may perform aspects of the described functions using special-purpose hardware.

At 705, the method may include retrieving a value from a mode register, the mode register indicating a plurality of voltage ranges of a supply voltage associated with the memory system, where the value indicates a first voltage range of the plurality of voltage ranges. In some examples, aspects of the operations of 705 may be performed by a mode register component 625 as described with reference to FIG. 6.

At 710, the method may include retrieving, from a read-only memory associated with the memory system, values of one or more parameters associated with operation of the memory system based at least in part on the value of the mode register, where each respective value of the one or more parameters is associated with the first voltage range. In some examples, aspects of the operations of 710 may be performed by a parameter value manager 630 as described with reference to FIG. 6.

At 715, the method may include operating the memory system according to the values of the one or more parameters based at least in part on retrieving the values from the read-only memory. In some examples, aspects of the operations of 715 may be performed by a memory system operating component 635 as described with reference to FIG. 6.

In some examples, an apparatus as described herein may perform a method or methods, such as the method 700. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for retrieving a value from a mode register, the mode register indicating a plurality of voltage ranges of a supply voltage associated with the memory system, where the value indicates a first voltage range of the plurality of voltage ranges; retrieving, from a read-only memory associated with the memory system, values of one or more parameters associated with operation of the memory system based at least in part on the value of the mode register, where each respective value of the one or more parameters is associated with the first voltage range; and operating the memory system according to the values of the one or more parameters based at least in part on retrieving the values from the read-only memory.

Aspect 2: The method, apparatus, or non-transitory computer-readable medium of aspect 1, further including operations, features, circuitry, logic, means, or instructions, or any combination thereof for adjusting a respective value of the one or more parameters to the values based at least in part on retrieving the values from the read-only memory.

Aspect 3: The method, apparatus, or non-transitory computer-readable medium of any of aspects 1 through 2, where the one or more parameters include one or more off-chip driver equalization parameters, one or more receiver properties, or any combination thereof.

Aspect 4: The method, apparatus, or non-transitory computer-readable medium of aspect 3, where the one or more receiver properties include one or more receiver strength parameters, one or more receiver operating point parameters, or any combination thereof.

Aspect 5: The method, apparatus, or non-transitory computer-readable medium of aspect 4, where the one or more receiver strength parameters include one or more frequency thresholds, each respective frequency threshold associated with a respective receiver strength.

Aspect 6: The method, apparatus, or non-transitory computer-readable medium of any of aspects 4 through 5, where the one or more receiver operating point parameters include one or more receiver operating points, each respective receiver operating points associated with a respective eye setting of the memory system.

Aspect 7: The method, apparatus, or non-transitory computer-readable medium of any of aspects 3 through 6, where the one or more off-chip driver equalization parameters include a respective pre-emphasis parameter, a respective de-emphasis parameter, or both for one or more frequency ranges and each respective pre-emphasis parameter and de-emphasis parameter is associated with a respective power consumption.

Aspect 8: The method, apparatus, or non-transitory computer-readable medium of any of aspects 1 through 7, where the read-only memory includes one or more fuses storing the values of the one or more parameters.

Aspect 9: The method, apparatus, or non-transitory computer-readable medium of any of aspects 1 through 8, where the read-only memory stores a look-up table indicating respective values of the one or more parameters, each respective value corresponding to a voltage range of the plurality of voltage ranges.

Aspect 10: The method, apparatus, or non-transitory computer-readable medium of any of aspects 1 through 9, where each voltage range of the plurality of voltage ranges corresponds to a respective data rate for communicating data with the memory system over a data channel.

Aspect 11: The method, apparatus, or non-transitory computer-readable medium of any of aspects 1 through 10, further including operations, features, circuitry, logic, means, or instructions, or any combination thereof for communicating data over a data channel using a modulation scheme that includes three or more symbols, where the plurality of voltage ranges are associated with communicating the modulation scheme.

Aspect 12: The method, apparatus, or non-transitory computer-readable medium of any of aspects 1 through 11, where the mode register includes a second indication of a second plurality of voltage ranges of a second supply voltage associated with the memory system.

Aspect 13: The method, apparatus, or non-transitory computer-readable medium of aspect 12, where the supply voltage includes a supply voltage for one or more input buffers of the memory system and the second supply voltage includes a supply voltage for one or more output buffers of the memory system.

Aspect 14: The method, apparatus, or non-transitory computer-readable medium of any of aspects 12 through 13, where the mode register includes a third indication of a plurality of operating frequencies for a write clock associated with the memory system.

It should be noted that the aspects described herein describe possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (e.g., in conductive contact with, connected with, coupled with) one another if there is any electrical path (e.g., conductive path) between the components that can, at any time, support the flow of signals (e.g., charge, current, voltage) between the components. A conductive path between components that are in electronic communication with each other (e.g., in conductive contact with, connected with, coupled with) may be an open circuit or a closed circuit based on the operation of the device that includes the connected components. A conductive path between connected components may be a direct conductive path between the components or may be an indirect conductive path that includes intermediate components, such as switches, transistors, or other components. In some examples, the flow of signals between the connected components may be interrupted for a time, for example, using one or more intermediate components such as switches or transistors.

A switching component (e.g., a transistor) discussed herein may be a field-effect transistor (FET), and may include a source (e.g., a source terminal), a drain (e.g., a drain terminal), a channel between the source and drain, and a gate (e.g., a gate terminal). A conductivity of the channel may be controlled (e.g., modulated) by applying a voltage to the gate which, in some examples, may result in the channel becoming conductive. A switching component may be an example of an n-type FET or a p-type FET.

The description set forth herein, in connection with the appended drawings, describes example configurations and does not represent all the examples that may be implemented or that are within the scope of the claims. The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Similar components may be distinguished by following the reference label by one or more dashes and additional labeling that distinguishes among the similar components. If just the first reference label is used in the specification, the description is applicable to any one of the similar components having the same first reference label irrespective of the additional reference labels.

The functions described herein may be implemented in hardware, instructions (e.g., code, software, firmware, logic) executed by a processing system (e.g., one or more processors, one or more controllers, control circuitry, processing circuitry, logic circuitry), or any combination thereof that is configured to cause a respective apparatus, device, or system to perform the described functions. If implemented as instructions executed by a processing system, the functions may be stored on or transmitted over as one or more instructions on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof, that are configured to cause the performance of the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The descriptions and drawings are provided to enable a person having ordinary skill in the art to make or use the disclosure. Various modifications to the disclosure will be apparent to the person having ordinary skill in the art, and the techniques disclosed herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method at a memory system, comprising:
retrieving a value from a mode register, the mode register indicating a plurality of voltage ranges of a supply voltage associated with the memory system, wherein the value indicates a first voltage range of the plurality of voltage ranges;
retrieving, from a read-only memory associated with the memory system, values of one or more parameters associated with operation of the memory system based at least in part on the value of the mode register, wherein each respective value of the one or more parameters is associated with the first voltage range; and
operating the memory system according to the values of the one or more parameters based at least in part on retrieving the values from the read-only memory.

2. The method of claim 1, further comprising:
adjusting a respective value of the one or more parameters to the values based at least in part on retrieving the values from the read-only memory.

3. The method of claim 1, wherein the one or more parameters comprise one or more off-chip driver equalization parameters, one or more receiver properties, or any combination thereof.

4. The method of claim 3, wherein the one or more receiver properties comprise one or more receiver strength parameters, one or more receiver operating point parameters, or any combination thereof.

5. The method of claim 4, wherein the one or more receiver strength parameters comprise one or more frequency thresholds, each respective frequency threshold associated with a respective receiver strength.

6. The method of claim 4, wherein the one or more receiver operating point parameters comprise one or more receiver operating points, each respective receiver operating points associated with a respective eye setting of the memory system.

7. The method of claim 3, wherein:
the one or more off-chip driver equalization parameters comprise a respective pre-emphasis parameter, a respective de-emphasis parameter, or both for one or more frequency ranges, and
each respective pre-emphasis parameter and de-emphasis parameter is associated with a respective power consumption.

8. The method of claim 1, wherein the read-only memory comprises one or more fuses storing the values of the one or more parameters.

9. The method of claim 1, wherein the read-only memory stores a look-up table indicating respective values of the one or more parameters, each respective value corresponding to a voltage range of the plurality of voltage ranges.

10. The method of claim 1, wherein each voltage range of the plurality of voltage ranges corresponds to a respective data rate for communicating data with the memory system over a data channel.

11. The method of claim 1, further comprising:
communicating data over a data channel using a modulation scheme that includes three or more symbols, wherein the plurality of voltage ranges are associated with communicating the modulation scheme.

12. The method of claim 1, wherein the mode register comprises a second indication of a second plurality of voltage ranges of a second supply voltage associated with the memory system.

13. The method of claim 12, wherein:
the supply voltage comprises a supply voltage for one or more input buffers of the memory system, and
the second supply voltage comprises a supply voltage for one or more output buffers of the memory system.

14. The method of claim 12, wherein the mode register comprises a third indication of a plurality of operating frequencies for a write clock (WCK) associated with the memory system.

15. A memory system, comprising:
one or more memory devices; and
processing circuitry coupled with the one or more memory devices and configured to cause the memory system to:
retrieve a value from a mode register, the mode register indicating a plurality of voltage ranges of a supply voltage associated with the memory system, wherein the value indicates a first voltage range of the plurality of voltage ranges;
retrieve, from a read-only memory associated with the memory system, values of one or more parameters associated with operation of the memory system based at least in part on the value of the mode register, wherein each respective value of the one or more parameters is associated with the first voltage range; and
operate the memory system according to the values of the one or more parameters based at least in part on retrieving the values from the read-only memory.

16. The memory system of claim 15, wherein the processing circuitry is further configured to cause the memory system to:
adjust a respective value of the one or more parameters to the values based at least in part on retrieving the values from the read-only memory.

17. The memory system of claim 15, wherein the one or more parameters comprise one or more off-chip driver equalization parameters, one or more receiver properties, or any combination thereof.

18. The memory system of claim 17, wherein the one or more receiver properties comprise one or more receiver strength parameters, one or more receiver operating point parameters, or any combination thereof.

19. The memory system of claim 18, wherein the one or more receiver strength parameters comprise one or more frequency thresholds, each respective frequency threshold associated with a respective receiver strength.

20. The memory system of claim 18, wherein the one or more receiver operating point parameters comprise one or more receiver operating points, each respective receiver operating points associated with a respective eye setting of the memory system.

21. The memory system of claim 17, wherein:
the one or more off-chip driver equalization parameters comprise a respective pre-emphasis parameter, a respective de-emphasis parameter, or both for one or more frequency ranges; and
each respective pre-emphasis parameter and de-emphasis parameter is associated with a respective power consumption.

22. A non-transitory computer-readable medium storing code, the code comprising instructions executable by one or more processors to:
retrieve a value from a mode register, the mode register indicating a plurality of voltage ranges of a supply voltage associated with a memory system, wherein the value indicates a first voltage range of the plurality of voltage ranges;
retrieve, from a read-only memory associated with the memory system, values of one or more parameters associated with operation of the memory system based at least in part on the value of the mode register, wherein each respective value of the one or more parameters is associated with the first voltage range; and
operate the memory system according to the values of the one or more parameters based at least in part on retrieving the values from the read-only memory.
